(19) United States
(12) Patent Application Publication
(10) Pub. No.: US 2012/0230634 A1
(43) Pub. Date: Sep. 13, 2012

(54) Radiation Waveguide Member

(76) Inventor: Geng Li, Nanning (CN)

(21) Appl. No.: 13/510,110

(22) PCT Filed: Nov. 17, 2010
(86) PCT No.: PCT/CN10/78815

§ 371 Date: May 16, 2012

(30) Foreign Application Priority Data
Nov. 17, 2009 (CN) 200920164850.X
May 7, 2010 (CN) 201010165105.4
Jul. 28, 2010 (CN) 201020273967.4

(51) Int. Cl. G02B 6/32; F24F 7/00; G02B 6/26

(52) U.S. Cl. 385/33; 385/42; 165/59

(57) ABSTRACT

A radiation waveguide member comprises a closed chamber provided with multilayer asymmetrical graded-index medium. The radiant heat exchange is unbalanced between the open surface of the closed chamber and a single heat source, and the positive and negative values of the net radiant heat flux is generated. An automatic directional waveguide of the radiation of the single source is formed from the negative-value open surface to the positive-value open surface. The radiation waveguide member enables aggregating a low-density energy flow into a high-density energy flow.

### TECHNICAL FIELD

The invention relates to a radiation waveguide technology, and more particularly to a technology of a multilayer quantum semitransparent body and components thereof.

### BACKGROUND

People cannot use excess heat energy around them in hot summer, and cannot use low-temperature heat radiation to warm themselves in cold winter.

Radiation is a material, and is a form of energy. Heat radiation is an inherent property of all objects. Object heat transfer is an unbalanced process of thermodynamics. Thermodynamic heat transfer depends on the thermodynamics temperature gradient. Heat is transferred by the macroscopic motion of object contact and the thermal motion of microscopic particles instead of being transferred by vacuum. Radiation has the duality of electromagnetic wave and quantum. Radiation heat transfer depends on electromagnetic waves. Heat is transferred by vacuum and medium in the conversion form of heat energy-radiation energy-heat energy. Therefore, thermodynamic heat transfer and radiation heat transfer are different in essence.

All the objects continuously emit heat radiation to the outside, and constantly absorb heat radiation of other objects at the same time. The difference of radiation exchanged between them is the radiation heat transfer amount among objects. For a system simply transferring heat by radiation, when the heat radiation emitted to the outside is equal to the heat radiation absorbed, the system is in heat balance; when the heat radiation emitted to the outside is more than the heat radiation absorbed, the temperature is reduced; conversely, the temperature is increased. The higher the object temperature is, the stronger the radiation capacity is. If the temperatures are the same, but the properties and surface conditions of objects are different, the radiation capacities are different, and the medium has different transmission, refraction, reflection and absorption capacities to the radiation of different wave length; therefore, the temperature is not the only determinant factor In a system purely transferring heat by radiation, many factors affect the quantity of the radiation of one surface to the other surface, and affect the radiant flux density, flux rate, and temperature distribution.

A light guide system, a gathering system, etc. of an optical device can guide and gather light radiation. However, at present, no matter the devices of end surface direct coupling, wedge-shaped film coupling, wedge-shaped optical fiber coupling, grating coupling, prism coupling or other devices, all the devices cannot rectify the alternating current (AC) quantum of the particles of a single heat source as an electronic semiconductor rectifying the AC. A structure capable of rectifying and gathering the unordered quantum of a single heat source is called a quantum semiconductor or quantum semitransparent body, semitransparent body for short.

The invention of radiation transmitter is of the structure of a semitransparent body. The geometric and medium factors of a closed chamber enable the arrival probabilities and arrival quantities of radiation between the open surfaces to be unequal, and the AC quantum between the open surface and a single heat source to be unbalanced; thus, an automatic directional waveguide is formed to become a semitransparent body.

The effective radiation of the surface heat transfer of an isothermal diffusion object is uniform. The radiation fraction of the radiation of the surface Ai directly arriving at the surface Aⱼ is called angular coefficient which is expressed by F [symbol] j; the radiation fraction of the radiation of the surface Ai directly arriving at the surface Aⱼ by reflection and re-radiation is called amended angular coefficient which is expressed by [symbol] j. The angular coefficient and the amended angular coefficient obey the reciprocal theorem: dAidFdAi−dAj=dAjdFdAj-dAi, Ai i−j=Aj j−i.

The sum of the radiation fractions of the radiation of n surfaces Ai arriving at one surface Aⱼ by projection, re-radiation, reflection, refraction, diffraction, coupling and gathering is angular coefficient f which is expressed by fᵢ₋ⱼ. The angular coefficient f comprises angular coefficient, amended angular coefficient, and interchangeability thereof; and further comprises the part without interchangeability. The angular coefficient for transferring heat from a low-temperature object to a high-temperature object is required to have no interchangeability.

The modern technology enables the radiation heat transfer between the open surfaces of the closed chamber of the single heat source to be unequal:

1. Graded index (GI) medium is divided into symmetric graded index (SGI) medium and non-symmetric gradient refractive index (NGI) medium, and the NGI medium is divided into reflection NGI medium and transmission NGI medium. SGI medium is applied to the communication optical fiber waveguide which obeys the reciprocal theorem, thereby reducing dispersion, reducing transmission loss, increasing communication capacity to a maximum extent, and having excellent performance.

Fermat's principle prompts that: during radiation heat transfer between the NGI low refractive index surface Ai and high refractive index surface Aⱼ, light is projected into the surface Aⱼ from the surface Aᵢ; when being emitted from the surface Aⱼ, the included angle with the normal line is ≦rₖⱼ; light can transmit through the NGI when the incident angle of light entering surface Ai is ≦rₖⱼ; light with incident angles of more than rₖⱼ always have inflection points of which the tangent line is in parallel with the Aⱼ; thus, light turns back to the surface Aⱼ, and cannot transmit through the NGI. Thus, rₖⱼ. is a transmission critical angle (called critical angle for short) of Aⱼ. Similarly, Ai also has a critical angle rₖᵢ. The light transmitting the NGI, no matter emergent light or incident light, the included angle between the light and Ai normal line must be less than or equal to rₖⱼ. The light transmitting the NGI only when the angle is equal to or less than the critical angle is called critical angle law. The critical angle law conforms to light reciprocity principle and Fermat's principle.

If blackbodies i, j for heat transfer on both sides of the NGI are isothermal, and have the same heat transfer areas, the radiation projected from i to j arrives at j at 100%, and n% radiation of the radiation projected to the outside of j turns back to arrive at j. The total radiation of i arriving at j is Eᵢ₋ⱼ+n% Eᵢ₋ⱼ=(1+n%)Eᵢ₋ⱼ, and v% radiation of the radiation projected to i from j turns back to Aⱼ at the effective distance of the inflection point. h% radiation of the radiation transmitting NGI turns back to be projected outside the blackbody i, and the total radiation of j arriving at i is (1-h%-v%) Eⱼ₋ᵢ. In accordance with the Stefan-Boltzmann law, Eᵢ₋ⱼ=Eⱼ₋ᵢ, (1+n%)Eⱼ₋ᵢ>(1-h%-v%)Eⱼ₋ᵢ, and heat flows from i to j.

The NGI radiation heat transfer is discussed by critical angle, solid angle and probability: the critical angle rₖ of the low refractive index is right angle, and all the hemispherical radiation Ei=j=2 π R² of the infinitesimal area of entering Ai arrives at Aj, thus, the probability of the unordered radiation of transmitting NGI is large. Only 2 π R² (1-cosrkj) radiation in the small critical angle rkj of the hemispherical radiation of the infinitesimal area of entering Aj is able to arrive at Ai. In accordance with Lambert's law, the directional radiation force of the diffuse radiation body changes with cosine, the energy transfer proportion of Ai and Aj transmitting NGI is Ej-i/Ei-j=2 π R² (1-cosrkj)/2 π R²=1-cosrkj<1, thus, the probability of the unordered radiation of transmitting NGI is small. All natural processes always proceed in the direction of unordered increase. Therefore, the NGI can transfer the heat of blackbody i to the isothermal and high temperature blackbody j in form of radiation, and the NGI transmission body is semitransparent body.

A semitransparent body belongs to the new technology and new field, has the own laws and many valuable properties. For example:

A. Having waveguide heat transfer law. The closed chamber is idealized: other surfaces of the closed chamber are mirror surfaces except the open surfaces; transparent medium which does not absorb radiation is arranged inside the closed chamber; both the medium and the mirror surfaces have no energy contribution to radiation heat transfer and do not cause energy loss; the reflectivity of the open surface is zero; and the radiation of the blackbody to the open surface is the radiation source of the open surface. The correlation, interaction and interplay of the geometric, medium and radiation factors of the heat transfer models of the closed chamber are enable the angular coefficient f of the open surface of the closed chamber to have no interchangeability, thereby becoming a semitransparent body. In accordance with the energy conservation law, Stefan-Boltzmann's law, and the concept of angular coefficient f, the heat flux of the heat transfer of the semitransparent body is solved by the effective radiation of a net radiation heat transfer method, obtaining the formulas:

$$\begin{matrix}{Φ}_{i - j} = σ {\sum }_{i = 1}^{n} ( {A}_{i} {T}_{i}^{4} {f}_{i - j} - {A}_{j} {T}_{j}^{4} {f}_{j - i} ) \\ and & ( 1 ) \\ {E}_{i \text{:} j} = {A}_{i \text{:} j} {f}_{i \text{:} j} {T}_{i \text{:} j}^{4} & ( 2 )\end{matrix}$$

To make the description of the embodiment be simple, suppose the technology of forming the semitransparent body is called semiconductor technology, the capacity of the semitransparent body automatically diffusing directional waveguide is called semiconductor capacity or semitransparent capacity for short. The NGI film needs to be supported by substrate, and the surface needs to be protected by a protecting film. However, the substrate and the protecting film only play the role of support and protection to the NGI. The description of the substrate and protecting film are omitted in the embodiment.

A closed chamber of such type exists in the single heat source: the angular coefficient f of the open surface has no interchangeability, the semiconductor technology enables the internal structure to automatically keep the unbalanced state of heat transfer between the open surfaces; thus, the positive and negative values of the net radiant heat flux of heat transfer between the open surfaces are generated, and the heat of the single heat source flows to the positive pole from the negative pole. It is known from the waveguide heat transfer law that the temperature difference Tⱼ-Tᵢ of the semitransparent body i which enables the heat of the blackbody i to flow to the blackbody j has a upper limit T′, the higher the T′ is, the higher the semiconductor capability of the semitransparent body is; conversely, the weaker the semiconductor capability is; when T′=0, no semiconductor capability exists. The value of T′, the value of energy flux Φᵢ₋ⱼ flowing from i to j, and the value of E_{i:j} of energy flux ratio are specific embodiments of strong or weak semiconductor capability of the closed chamber. When Eⱼ₋ᵢ→0,E_{i,j}→∞, a black semitransparent body is called.

T′→0, the semiconductor capability tends to be 0. The temperature difference in the single heat source is 0. The non-semitransparent body arranged in the single heat source must have no semiconductor capability, and the semitransparent body arranged in the single heat source should have semiconductor capability. Thus, whether semiconductor capability exists in the single heat source becomes a method for distinguishing whether the semiconductor can become a semitransparent body.

The semitransparent body is characterized in that: the closed chamber is provided with multilayer medium, the radiation heat transfer is unbalanced between the open surface of the closed chamber and a single heat source, and the positive and negative values of the net radiant heat flux are generated; and an automatic directional waveguide of the radiation of the single source is formed from the negative-value open surface to the positive-value open surface.

To facilitate describing the technical scheme, the device formed by the semitransparent body is called a semitransparent device, the semitransparent body capable of gathering low-density radiation into high-density radiation for output is called a radiation gathering rectifier, and the semitransparent body which cannot gather the low-density radiation into high-density radiation is called rectifier.

The technical scheme which enables the closed chamber to have semitransparent capability and increase semitransparent capability comprises:

A. Modulating the geometric and medium factors to increase semitransparent capability.

B. Selecting medium capable of transmitting or reflecting appropriate frequency spectrum. And

C. Forming a semitransparent device by a quantum semitransparent body and other technological devices.

The A technical scheme is achieved by the following measures:

a. The geometric factor is matched with the medium factor, to increase the semitransparent capability.

The single layer NGI is superposed into multilayer NGI (two layer or more is called multilayer), as shown in FIG. 1.

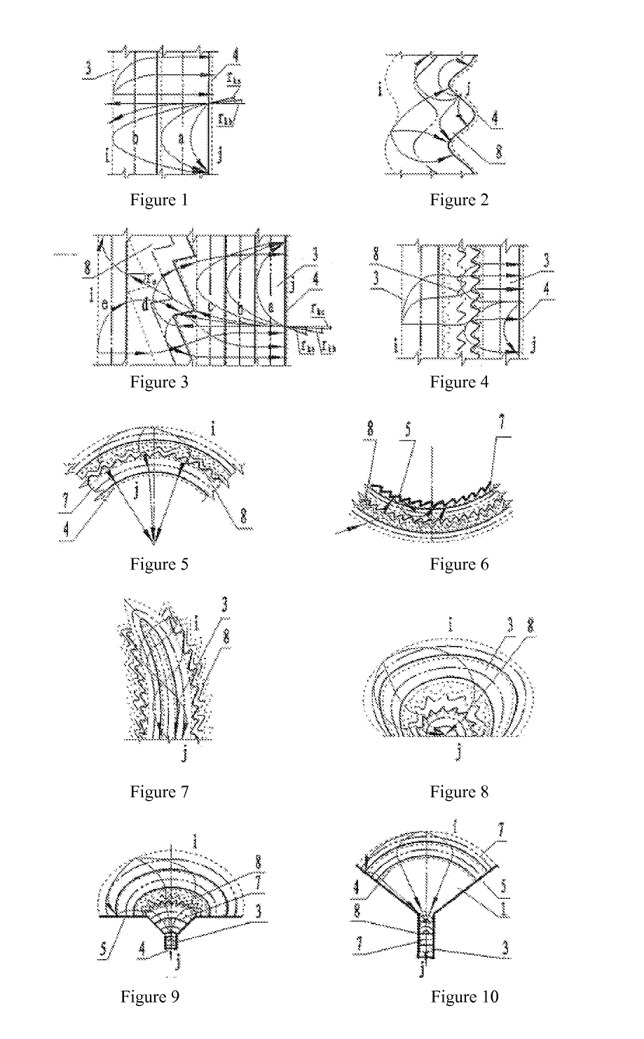

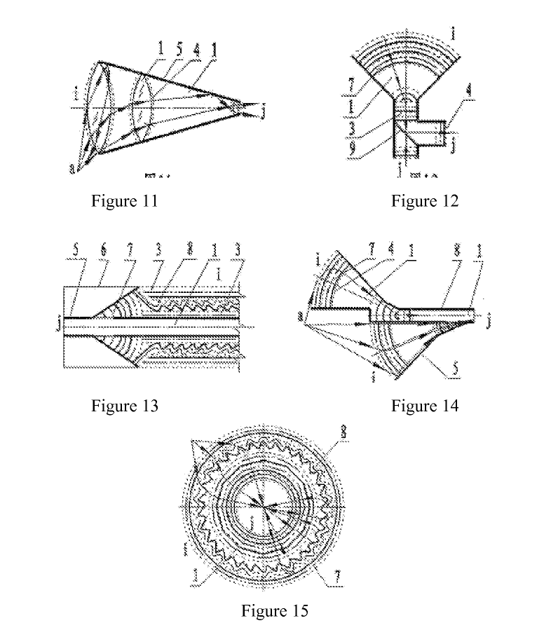

The shapes of the refractive index distributions of the NGI cross section is changed to increase the semitransparent capability: the parallel shape of the refractive index distributions of the NGI cross section (parallel NGI) or the unparallel shape of the refractive index distributions of the NGI cross section (unparallel NGI)can be changed into various shapes of the refractive index distributions of the cross section such as wave shape (as shown in FIG. 2), similar wave shape (as shown in FIG. 3), circular arc shape (referred as circular arc NGI, as shown in FIG. 5), similar cone shape (as shown in FIG. 7), and half oval shape (as shown in FIG. 8) .

Wave-shaped NGI and unparallel NGI are sandwiched between multilayer NGI (called wave-shaped sandwich layer), as shown in FIG. 3 and FIG. 4.

b. Different media and different structures are matched to increase the semiconductor capability:

The object of which the positive pole is provided with a sawtooth mirror surface (as shown in FIG. 6) or the infrared absorptivity is high.

Waveguides of this type are paved in the buildings of cities to gather heat radiation and drive heat engines to generate electricity, thereby favoring city cooling, and meeting the requirement of residential electricity.

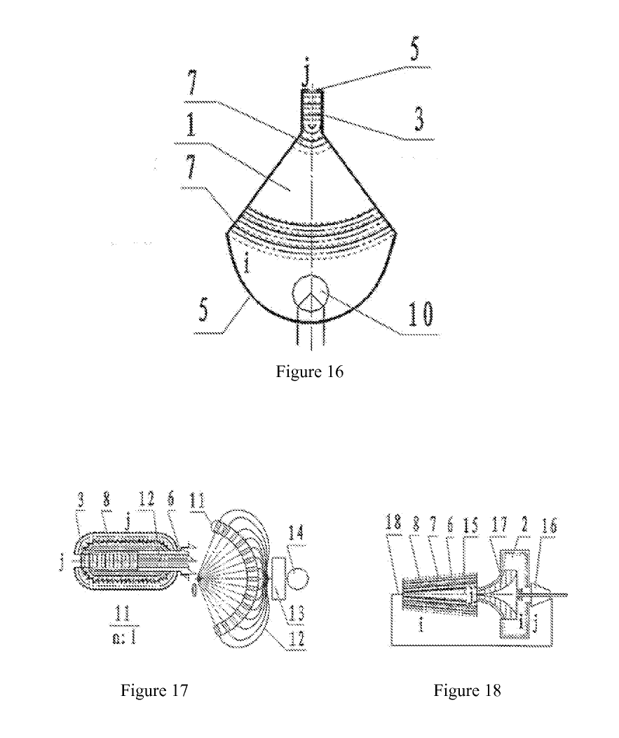

As shown in FIG. 16, an NGI funnel mirror radiation gathering rectifier is combined with the modulated radiation source and a reflecting mirror. The modulated radiation source inputs the radiation into the funnel radiation gathering rectifier, and the reflecting mirror 5 reflects the radiation to the radiation gathering rectifier. The small open surface of the funnel mirror of the radiation gathering rectifier is provided with hemispheric NGI to gather the radiation entering the radiation gathering rectifier to the center of sphere, and the gathered radiation is regulated by the parallel NGI into parallel radiation to be emitted. If the emitted radiation is required to form a very thin light beam, the mirror surface can be arranged on the positive pole. Only the superfine light beam is emitted, and the radiation around the light beam is reflected back to be regulated again and then reradiated; thus, thin light beam with strong directionality can be obtained. If the radiation source is infrared radiation, the thin light beam can be used for cutting or welding; if the radiation source has information, the radiation source can be used for communication.

FIG. 17 is a schematic diagram of a normal light picker and a normal light imager. The shell of the normal light picker is made of a black semitransparent body, the surface j of the black semitransparent body faces outwards, and the surface i faces inwards. A channel is arranged in the shell, and multilayer parallel NGI is arranged in the channel. The surface j faces outwards, the surface i faces inwards, and the surface i faces the optical fiber. The shell is made of parallel NGI between which similar wave-shaped NGI is sandwiched. The surface j faces outwards, to only allow radiation to be transmitted outside, but not allow radiation to be transmitted inside; thereby guaranteeing low temperature in the shell and no side radiation interference in the shell. The surface j of the multilayer parallel NGI of the channel faces outwards, to only allow the light of the normal line to arrive at the optical fiber; thus, all the other light are bent to be output form the shell, and the radiation of the multilayer parallel NGI is only output to the surface j and the shell, thereby guaranteeing low temperature in the shell and no normal-temperature spontaneous radiation interference in the shell. Therefore, the optical fiber can only receive the radiation entering from the normal line of the multilayer parallel NGI. The diameter of the normal light picker is as large as that of optical fiber. Normal light pickers of sufficient number face one focus, to pick sufficient pixels to be transmitted to the display by the optical fiber and the electronic computer, thereby forming clear three-dimensional image and relevant analysis. Because the picked light is natural light or spontaneous radiation of object, the picked light can be applied to various nondestructive observation and analysis, comprising images of spontaneous radiation for transmitting and analyzing human organs, to help diagnosis and treatment, and can further be applied to make infrared telescopes, visible-light telescopes or oversized astronomical telescopes.

FIG. 18 shows a multilayer NGI quantum heat engine of semitransparent body. An air outlet of a heat container is connected with an air inlet of the heat engine, an air outlet of the heat engine is connected with an air inlet of a cold container, an air outlet of the cold container is connected with an air inlet of a compressor, and an air outlet of the compressor is connected with an air inlet of the heat container by a heat carrier channel. The surface j of the multilayer NGI radiation gathering rectifier faces the heat container, and a gap is reserved between the surface j and the container, to reduce thermodynamic heat transfer. The surface i of the multilayer NGI radiation gathering rectifier faces the cold container. The heat carrier absorbs the heat radiation transported by the radiation gathering rectifier, to rapidly increase temperature and voltage and drive the heat engine to rotate. The absorbed heat radiation enters the cold container to reduce pressure and voltage, then enters the compressor, and enters the heat container for circulation again after passing through the heat carrier channel, to form a closed system of the heat carrier. The rotating crankshaft of the heat engine drives the compressor to operate.

We claim:

1. A closed chamber with multilayer medium, wherein said closed chamber is provided with multilayer medium; the radiation heat transfer is unbalanced between the open surface of said closed chamber and a single heat source, and the positive and negative values of the net radiant heat flux is generated; and an automatic directional waveguide of the radiation of the single source is formed from the negative-value open surface to the positive-value open surface.

2. The closed chamber with multilayer medium of claim 1, wherein a convex lens is arranged in a funnel mirror surface.

3. The closed chamber with multilayer medium of claim 1, wherein multilayer non-symmetric graded-index (NGI) medium is arranged in said funnel mirror surface; the high refractive index surface of said medium faces the small open surface of said funnel mirror surface.

4. The closed chamber with multilayer medium of claim 1, wherein phase step refractive index medium and multilayer NGI medium are arranged in said funnel mirror surface; the high refractive index surface of said medium faces the small open surface of said funnel mirror surface; the refractive index distributions of the cross section of said medium can be in various shapes such as parallel shape, unparallel shape, wave shape, similar wave shape, circular arc shape, similar cone shape and half oval shape, and said various shapes can be mutually overlapped.

5. The closed chamber with multilayer medium of claim 1, wherein said closed chamber is formed by NGI medium; the refractive index distributions of the cross section of said NGI medium can be in various shapes such as parallel shape, unparallel shape, wave shape, similar wave shape, circular arc shape, similar cone shape and half oval shape, and said various shapes can be mutually overlapped.

6. The closed chamber with multilayer medium of claim 1, wherein said closed chamber with multilayer medium forms a structure together with other closed chambers.

7. The closed chamber with multilayer medium of claim 1, wherein said closed chamber with multilayer medium is used for arranging diaphragm and frequency selecting medium.

8. The closed chamber with multilayer medium of claim 1, wherein multilayer graded-index (GI) medium is arranged in said funnel mirror surface; the high refractive index surface of said medium faces the small open surface of said funnel mirror surface, and a modulated radiation source and a mirror surface are arranged on the front part of the big open surface of said funnel mirror surface.

9. The closed chamber with multilayer medium of claim 1, wherein said closed chamber forms a pipeline; the open surface with net radiant heat flux of a negative value of said closed chamber faces said pipeline, and one section of said pipeline is provided with NGI medium of which the refractive index distributions of the cross section are parallel; the open surface with net radiant heat flux of a negative value faces inwards, and the other section of said pipeline is connected with an optical fiber.

10. The closed chamber with multilayer medium of claim 1, wherein the NGI open surface with net radiant heat flux of a positive value faces a heat container; a heat carrier is contained in said heat container, an air outlet of said heat container is connected with an air inlet of a heat engine, an air outlet of said heat engine is connected with an air inlet of a cold container, an air outlet of said cold container is connected with an air inlet of a compressor, and an air outlet of said compressor is connected with an air inlet of said heat container by said heat carrier channel; the NGI open surface with net radiant heat flux of a negative value faces said cold container.
